(19) United States
(12) Patent Application Publication
(10) Pub. No.: US 2016/0003932 A1
(43) Pub. Date: Jan. 7, 2016

(54) Method and System for Estimating Error in Predicted Distance Using RSSI Signature

(71) Applicant: Lexmark International, Inc., Lexington, KY (US)

(72) Inventors: Julie Ann Gordon Whitney, Georgetown, KY (US); John Thomas Fessler, Lexington, KY (US); Zachary Charles Nathan Kratzer, Lexington, KY (US); Johne' Michelle Parker, Lexington, KY (US); Nathan Bradley Jacobs, Lexington, KY (US); Ann Michelle Whitney, Georgetown, KY (US)

(21) Appl. No.: 14/790,823

(22) Filed: Jul. 2, 2015

Related U.S. Application Data
(60) Provisional application No. 62/020,814, filed on Jul. 3, 2014.

(51) Int. Cl. G01S 5/00; G01S 5/02; G06K 7/10

(52) U.S. Cl. CPC G01S 5/0036; G06K 7/10366; G01S 5/0294; G01S 5/0205

(57) ABSTRACT

A localization method and system, including calculating a first distance estimate of a distance between a radio frequency identification (RFID) tag and a reader based on information associated with at least one of a plurality of response signals received from the RFID tag in response to interrogation signals by the reader at a plurality frequencies, measuring a signal strength of each of the received plurality of response signals to create a received signal strength indicator (RSSI) signature, predicting an error in the first distance estimate using the RSSI signature, and determining a final distance estimate of the distance by modifying the first distance estimate based on the predicted error.

### CROSS REFERENCES TO RELATED APPLICATIONS

The present application is related to and claims priority under 35 U.S.C. 119(e) from U.S. provisional application No. 62/020,814, filed Jul. 3, 2014, entitled, “Method and System for Estimating Error in Predicted Distance Using RSSI Signature,” the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to radio frequency identification (RFID) systems, more particularly, to methods for estimating error in distance predictions using received signal strength indicator (RSSI) signatures.

2. Description of the Related Art

In recent years, localization systems have been used in many applications to identify and track different physical entities such as merchandise, equipment, devices, personnel or individuals, and other items or assets that need to be monitored within a particular environment. Example applications include supply chain management applications where localization systems are used for automatic inventory and tracking, and security applications where such services are used to identify and monitor personnel to control access to particular areas within a facility.

Radio frequency identification (RFID) systems have been widely employed for localization due to relatively low implementation cost. An RFID system typically attaches an RFID tag to an object to be monitored. Readers are then deployed in the environment to interrogate the tag as the tagged object passes within range of the readers. The readers transmit radio frequency (RF) signals to the tag which in turn responds by transmitting an RF response signal containing information identifying the object to which the tag is attached. The response signals received by each reader are then transformed into distance measurements which are utilized to determine an estimate of the location of the tagged object. The accuracy of distance estimation, therefore, directly affects the performance of the localization of RFID tags.

Application of RFID systems for localization of RFID tags is often difficult because of challenges in the presence of multipath effects caused by reflection of the backscattered signal off of walls and other objects within the environment. For example, when using RSSI to predict distance, multipath effects causes signals to traverse different paths towards the reader which consequently results to variation in signal strength received by the reader, and thus some level of error in distance estimation. For phase-based distance measurements, multipath also causes phase distortion as signals traverse different paths and arrive at the reader with varying delays, causing inconsistencies with respect to phase readings which consequently results to error in phase-based distance estimation.

Accordingly, there is a need for improved RFID distance estimation and localization techniques.

### SUMMARY

Embodiments of the present disclosure provide methods and systems for determining a distance between a radio frequency identification (RFID) tag and a reader. The method includes calculating a first distance estimate of the distance based on information associated with at least one of a plurality of response signals received from the RFID tag in response to interrogation signals by the reader at a plurality of frequencies. The method further includes measuring a signal strength of each of the received plurality of response signals to create a received signal strength indicator (RSSI) signature, predicting an error in the first distance estimate using the RSSI signature, and determining a final distance estimate of the distance by modifying the first distance estimate based on the predicted error. The final distance estimate may be used as one of multiple final distance estimates by multiple readers in determining a relative location of the RFID tag.

### BRIEF DESCRIPTION OF THE DRAWINGS

The above-mentioned and other features and advantages of the disclosed example embodiments, and the manner of attaining them, will become more apparent and will be better understood by reference to the following description of the disclosed example embodiments in conjunction with the accompanying drawings, wherein:

FIG. 1 illustrates an object detection system including an RFID tag detection device and a plurality of RFID tags, according to an example embodiment.

FIG. 2 illustrates a relationship between RFID tag distance and RSSI according to an example embodiment.

FIG. 3 illustrates communication between a radio device and an RFID tag in the object detection system of FIG. 1.

FIG. 4A illustrates plurality of phase angle measurements at different hop frequencies over a frequency range forming a generally sawtooth wave, according to an example embodiment.

FIG. 4B illustrates a transformed linear phase trend of the phase angles in FIG. 4A.

FIGS. 5A-5F illustrate example RSSI signature patterns taken in different environmental conditions.

FIGS. 6A and 6B illustrate an RSSI signature pattern and a phase pattern, respectively, obtained in an original environment.

FIGS. 7A and 7B illustrate an RSSI signature and a phase pattern, respectively, obtained after the original environment described in FIG. 6A-6B is altered.

FIG. 8 illustrates a block diagram including a trainer for defining an error prediction function that outputs predicted errors in distance estimations, according to an example embodiment.

FIG. 9 is a flowchart illustrating an example process of training the trainer for defining the error prediction function in FIG. 8, according to an example embodiment.

FIG. 10 is a flowchart illustrating an example method of obtaining an RSSI signature and actual distance error associated therewith that are both fed into the training engine in FIG. 8 as training examples, according to an example embodiment.

FIG. 11 is a flowchart illustrating an example process of predicting distance of an unknown tag and predicting error in the predicted distance, according to an example embodiment.

FIG. 12 is a block diagram illustrating a network of RFID tag detection devices according to an example embodiment.

FIG. 13 illustrates a schematic diagram of multiple radio devices defining an uncertainty ring around a predicted location of an unknown tag.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

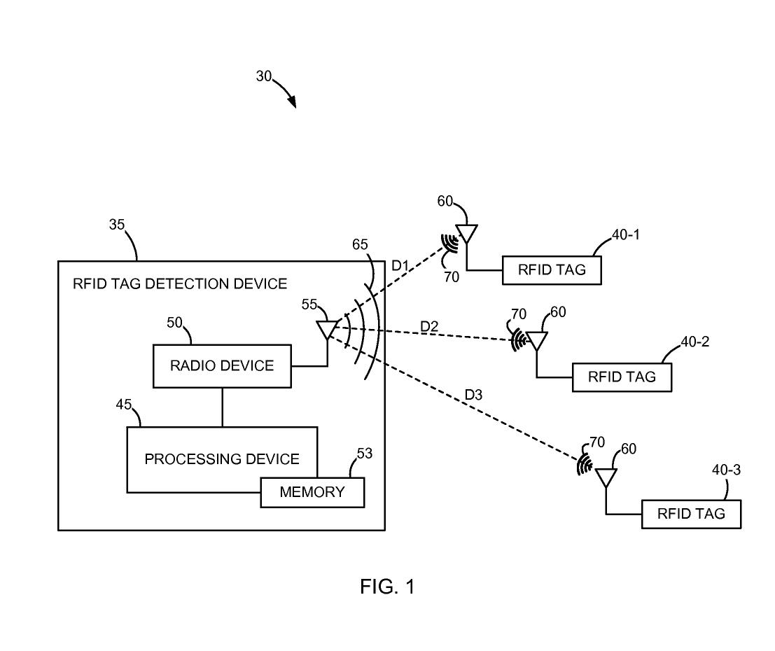

FIG. 1 shows an illustration of an object detection system 30 that may be used to provide localization services for identifying, determining, and tracking physical locations of different assets, equipment, devices, individuals, or other objects in a particular environment. As shown, object detection system 30 includes a radio frequency identification (RFID) tag detection device 35 and a plurality of RFID tags 40 that are attachable to objects of interest that need to be tracked. RFID tag detection device 35 includes a processing device 45 and a radio device 50, such as a radio transceiver or transponder, communicatively coupled to processing device 45. Processing device 45 may include an associated memory 53 and may be a processor, microprocessor, controller and/or microcontroller formed as one or more Application Specific Integrated Circuits (ASICs). Memory 53 may be any memory device convenient for use with or capable of communicating with processing device 45. Processing device 45 may communicate with radio device 50 and serve to provide data to radio device 50 for transmission thereby, or to receive data therefrom for processing. In other alternative embodiments, RFID tag detection device 35 may be implemented in a variety of ways. For example, processing device 45 may be implemented as part of radio device 50 and may execute instructions maintained in memory 53 for performing operations or functions associated with radio device 50.

Radio device 50 may be derived from a wide variety of RFID readers capable of reading a number of passive, active, and/or semi-passive tags simultaneously within a read/interrogation range. Radio device 50 may include at least one antenna 55 and a circuit that is configurable to operate as a transmitter and a receiver. Radio device 50 generally uses antenna 55 to transmit radio frequency signals to the RFID tags 40 and receive response signals therefrom. Antenna 55 may be tuned to one or more frequencies at which radio device 50 interrogates and communicates with a particular RFID tag 40 within range. Antenna 55 may be implemented with one or more antennae.

Each RFID tag 40 may be a passive, active, or semi-passive tag, and may include a communications control unit (not shown) and an antenna 60. The communications control unit of each RFID tag 40 may decode and/or demodulate received information/interrogation signals from radio device 50, and encode, modulate, and transmit information/response signals to radio device 50 using antenna 60. Antenna 60 may be tuned to a frequency or frequencies at which radio device 50 communicates with RFID tag 40.

In operation, radio device 50 may broadcast a plurality of interrogation signals in the form of electromagnetic waves 65 to RFID tags 40 within interrogation range. In response, each RFID tag 40 within range may return a response signal in the form of electromagnetic waves 70 to radio device 50. Radio device 50 may use characteristics of received response signals to determine information associated with the responding RFID tag 40. For example, radio device 50 may identify a responding RFID tag and determine a distance Dₙ thereof based on response signals received therefrom.

In an example embodiment, RFID tag detection device 35 may be configured for and/or capable of measuring RSSI of a response signal received from a responding RFID tag 40, and calculating a distance estimate of the RFID tag 40 based on the measured RSSI. As conventionally known, a response signal transmitted by an RFID tag loses power as it travels through air due to reflection, refraction, absorption, and other environmental factors. Thus, as the distance between an RFID tag and radio device 50 increases, signal strength of response signals received by radio device 50 generally decreases. For example, in FIG. 1, three RFID tags 40-1, 40-2, and 40-3 are illustrated with RFID tag 40-1 being relatively closest to radio device 50 at a distance D1 and then increasing in distance with RFID tags 40-2 and 40-3 at distances D2 and D3, respectively. Accordingly, response signals transmitted by RFID tag 40-1 may be stronger in signal strength as received by radio device 50 compared to signal strengths of response signals received from RFID tags 40-2 and 40-3. Radio device 50 can receive a response signal from an RFID tag 40 using antenna 55 and decode the received response signal to identify the RFID tag 40. Additionally, the amplitude of the received response signal may be examined to obtain a measure of RSSI associated with the received response signal. The measured RSSI may then be used to calculate a distance estimate of the RFID tag 40.

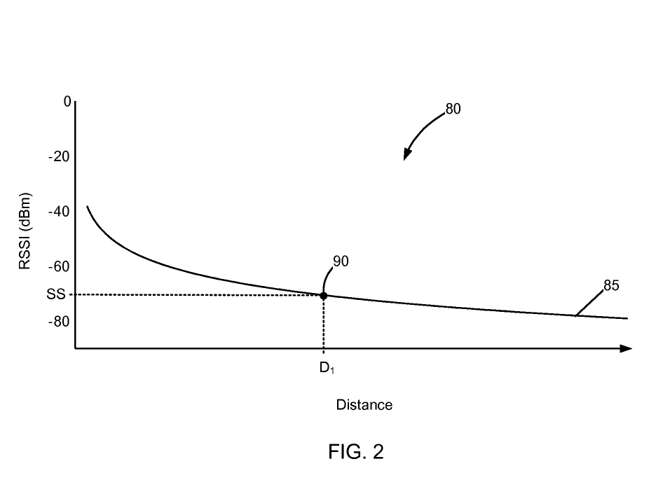

As an example, a distance estimate may be determined based on an empirically determined relationship between RSSI and reader to tag distance. For example, in FIG. 2, a graph 80 having a curve 85 that represents a relationship between RSSI and distance is illustrated. For a given RSSI value, a corresponding distance may be determined using curve 80. For example, an RSSI value SS may correspond to a point 90 on curve 80 and has a corresponding distance D which may constitute the distance estimate. It will be appreciated that graph is presented for purposes of illustration and, thus, should not be considered limiting. In other alternative embodiments, other techniques for determining distance estimates based on RSSI measurements may be used.

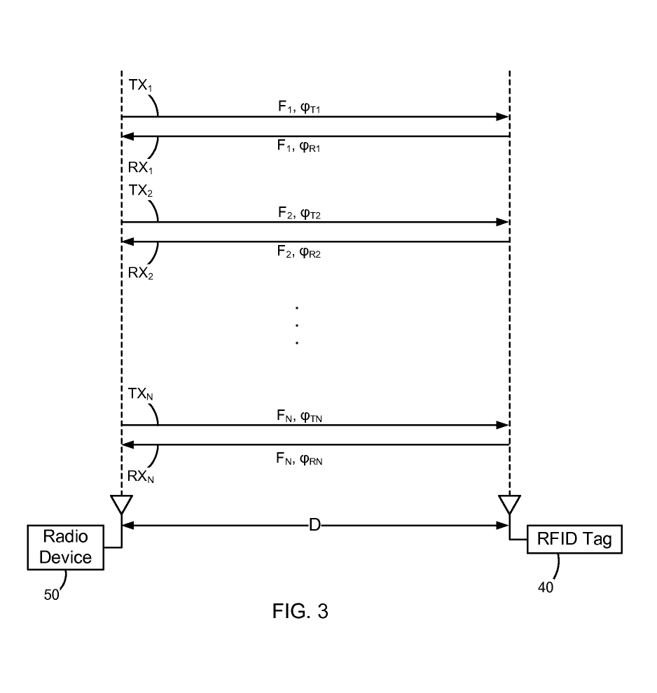

In another example embodiment, RFID tag detection device 35 may be configured for and/or capable of measuring phase associated with response signals received from RFID tags 40. With reference to FIG. 3, an example communication between radio device 50 and RFID tag 40 is illustrated. Radio device 50 may transmit a plurality of signals TX₁, TX₂, . . . , TX_{N} at different frequencies F₁, F₂, . . . F_{N}, respectively, to interrogate RFID tag 40. A carrier frequency at which a signal is transmitted can be any available or permitted frequency in the radio frequency spectrum. For example, carrier frequencies may be selected from an available set of frequencies in a frequency hopping system in a particular geographic location. In an example embodiment, selected carrier frequencies may be spaced apart by known or predetermined frequency intervals. In another example embodiment, frequency selection may be random. In still another example embodiment, selected frequencies may be substantially distributed over the available range of frequencies. As will be appreciated, any suitable carrier frequencies may be selected.

Radio device 50 may receive response signals RX₁, RX₂, . . . , RX_{N} for each transmitted signal TX₁, TX₂, . . . , TX_{N} at corresponding frequencies F₁, F₂, . . . , F_{N} from RFID tag 40. In this example, transmitted signals TX₁, TX₂, . . . , TX_{N} may be transmitted by radio device 50 with initial phases φ_{T1}, φ_{T2}, . . . , φ_{TN}, respectively. Signal phase may be determined using any of a variety of techniques known in the art. Upon arriving at radio device 50, response signals RX₁, RX₂, . . . , RX_{N} may have respective phases φ_{R1}, φ_{R2}, . . . , φ_{RN} that differ from the initial phases φ_{T1}, φ_{T2}, . . . , φ_{TN} of corresponding interrogation signals TX₁, TX₂, . . . , TX_{N}. Phases φ_{R1}, φ_{R2}, . . . , φ_{RN} of the received response signals RXₙ generally varies with each frequency Fₙ, and this variation in phase with respect to the change in frequency is proportional to the reader to tag distance. Accordingly, RFID tag detection device 35 may utilize the changes in phase to calculate an estimate of the distance D between radio device 50 and RFID tag 40. Phase-based distance estimates may be determined using different techniques known in the art.

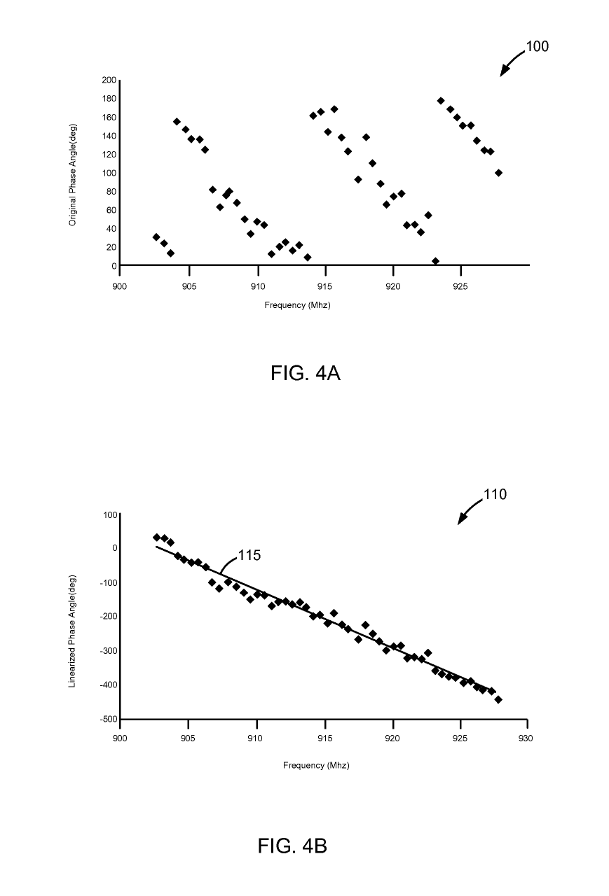

As an example, FIG. 4A shows a graph 100 illustrating a plurality of phase angle measurements taken at 50 different hop frequencies over a frequency range for a given tag to reader distance. As shown, the change in phase angle as a function of change in frequency is generally periodic and follows a sawtooth wave shape. The change in phase angle with respect to the change in frequency is proportional to the reader to tag distance, and thus can be used to determine a distance estimate between tag and reader. In order to calculate the rate of change of the phase over the range of frequencies, the sawtooth wave in FIG. 4A can be transformed into a substantially linear function by altering the phase angles at appropriate locations until a linear phase trend is achieved, as shown by graph 110 in FIG. 4B. A line 115 can then be “best fit” to the phase angles, the slope of which representing the rate of change of phase over the range of frequencies. Based on the slope of line 115, a distance estimate can be predicted, such as by using the following Equation (1):

$$d = - \frac{c}{4 π} \frac{\partial ϕ}{\partial f} + β \qquad Eq . ( 1 )$$

where d is the distance between RFID tag and radio device, c is the speed or light,

$$\frac{\partial ϕ}{\partial f}$$

is the phase slope, and β is an empirically determined distance offset value used to correct distance calculation. For example, the value of β can vary depending on the particular setup of equipment used in the system, such as based upon the coupling and length of the cable between radio device 50 and antenna 55. Using Eq. (1), phase slope can be calculated given a particular distance, and conversely, distance can be calculated given a particular phase slope. Thus, given the phase slope of line 115, a distance estimate can be calculated using Eq. (1).

Object detection system 30 may perform distance measurements on a given RFID tag 40 of interest using techniques that utilize RSSI and/or phase of response signals received from the RFID tag of interest, and, additionally, may predict errors in the distance measurements. While there may be several causes of errors in the distance estimations, one of the major causes can be multipath. In accordance with example embodiments of the present disclosure, RSSI signatures may be used to compensate for errors in distance estimations due to multipath.

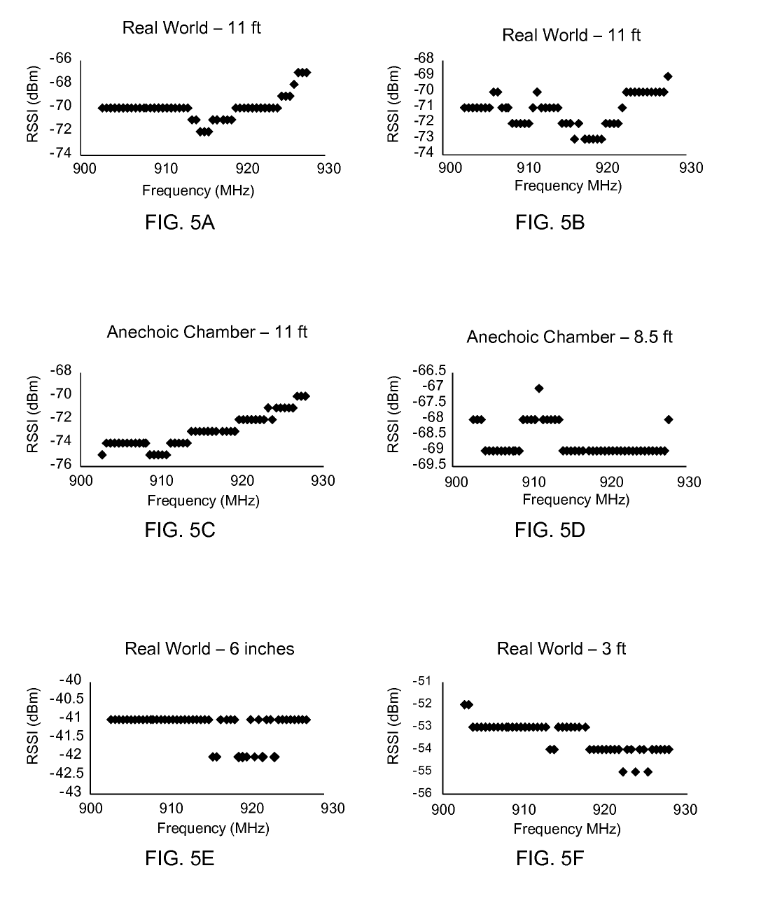

An RSSI signature, as used herein, includes a plurality of RSSI values measured over a range of frequencies, such as at each of the 50 hop frequencies in FIG. 4A, for a given separation distance between RFID tag and reader. FIGS. 5A-5F show examples of RSSI signatures taken at various environmental conditions. FIG. 5A shows an RFID signature measured in a real world environment with a separation distance of about 11 feet. FIG. 5B shows an RFID signature measured with the same 11-ft separation distance and orientation between RFID tag and reader as in FIG. 5A, but with the arrangement moved through the real world environment. FIGS. 5C and 5D illustrate RSSI signatures measured in an anechoic chamber with separation distances of about 11 ft and 8.5 ft, respectively. FIGS. 5E and 5F illustrate RSSI signatures measured in a real world environment with separation distances of about 6 in and 3 ft, respectively. RSSI signature patterns, in general, may vary depending upon separation distance as well as the physical environment.

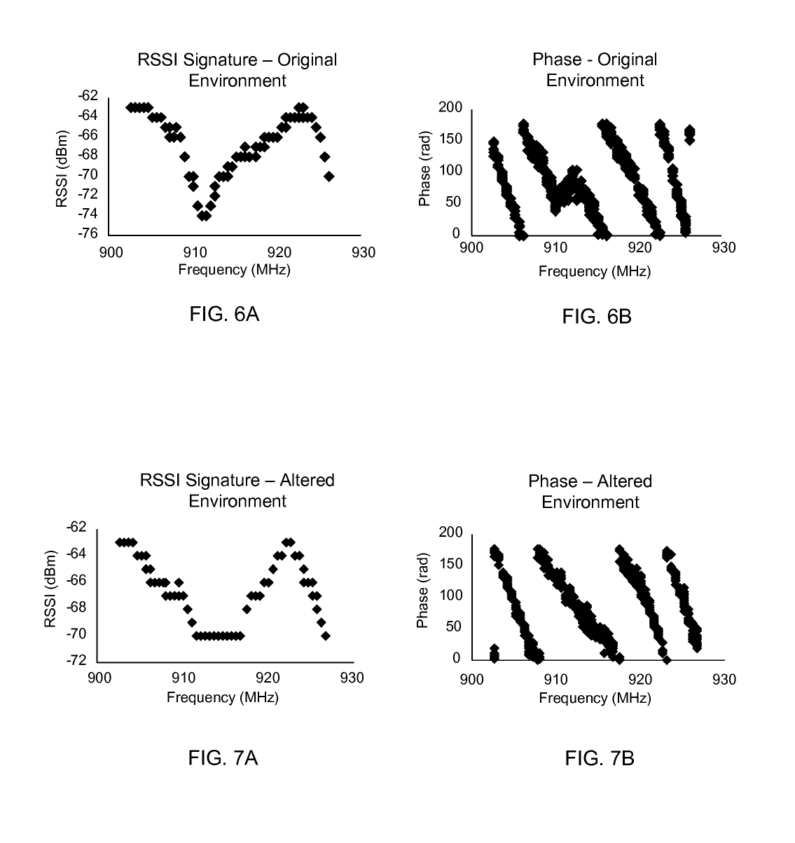

RFID signatures are typically sensitive to multipath. That is, keeping the reader to RFID tag distance substantially constant, changes in the physical environment can cause different multipath distributions which in turn cause variation in RSSI strengths over the range of frequencies. To illustrate this, FIGS. 6A and 7A are depicted which show RSSI patterns obtained before and after a particular environment is altered, respectively. Altering an environment, such as by moving or adding objects therein, causes response signals to travel different paths from the RFID tag to the reader and, thus, to have different attenuation levels and signal strength as they reach the reader. As can be seen in FIG. 7A, changes occur in a few RSSI strength values in the middle of the frequency range after altering the environment, which is caused in part by multipath variations. In some cases, relatively small changes in the physical environment may result in a relatively significant change in an RSSI signature. Thus, changes in multipath generally affect the shape of an RSSI signature.

Timing variation between response signals as they traverse different paths toward the reader may also cause phase distortion. To illustrate this, FIGS. 6B and 7B are depicted which show phase patterns obtained before and after the same particular environment described with respect to FIGS. 6A and 7A is altered, respectively. As shown, the shape of phase pattern changes due to some phase measurements in the middle of the frequency range being altered, which is caused in part by multipath variations. Thus, multipath variation not only causes changes in RSSI signature but also causes changes in phase pattern.

Since multipath affects the shape of an RSSI signature, RSSI signatures can be used as representations of multipath in the environment. Techniques provided herein utilize RSSI signatures to determine error in predicted distances caused by multipath in the environment. More particularly, because errors in distance measurements are caused in part by multipath effects, RSSI signatures may be correlated to an amount of error in RSSI-based distance measurements. Additionally, because the same multipath that causes changes in RSSI signature also causes changes in phase measurements, the RSSI signature may also be correlated to an amount of error in phase-based distance measurements. In this way, RSSI signatures may be used to predict errors in distance estimates, and such predicted errors may be used to provide more accurate distance estimates.

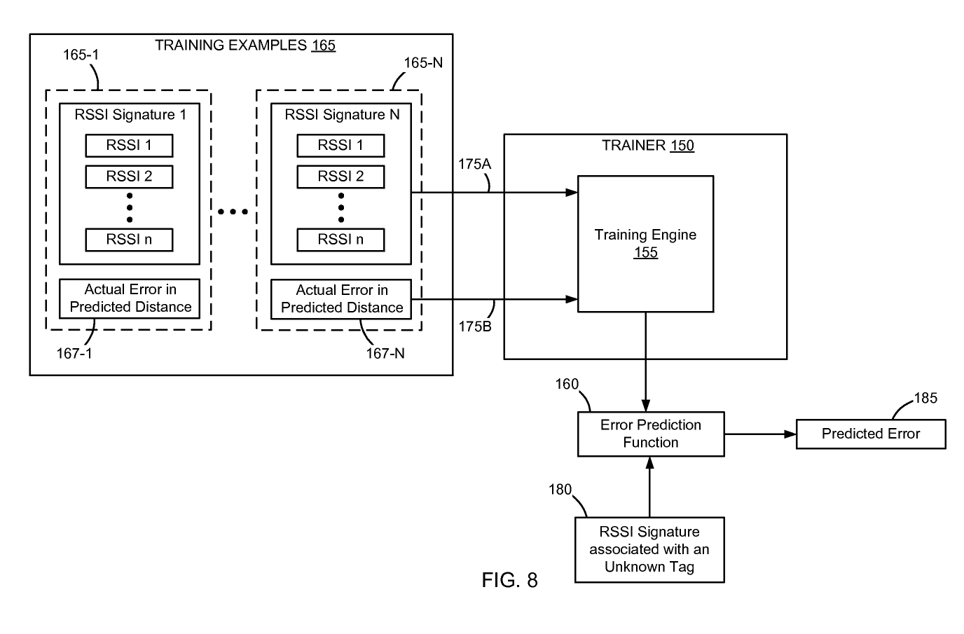

According to an example embodiment, object detection system 30 may utilize one or more machine learning algorithms to predict errors associated with distance measurements. FIG. 8 illustrates an example block diagram including a trainer 150 having a training engine 155 that employs one or more machine learning algorithms to define an error prediction function 160. Trainer 150 may be implemented using a computing device coupled with a reader that is substantially the same as an operational reader used by RFID tag detection device 35. The reader associated with trainer 150 is used to obtain a plurality of RSSI signatures from a plurality of test RFID tags in various test environments to be used as training examples. In an example embodiment, trainer 150 may use neural networks to analyze data and recognize RSSI signature patterns, and define error prediction function 160.

Training engine 155 may be provided with training examples 165 comprising RSSI signatures 1 to N and corresponding errors 167 in RSSI or phase predicted distances. One RSSI signature includes a plurality of RSSI values 1 to n, such as 50 RSSI values taken at the 50 hop frequencies, which generally serve as input features provided at input 175A of trainer 150. A corresponding error 167, on the other hand, serve as target output for an RSSI signature received by training engine 155 via input 175B of trainer 150, and which is defined as an actual error determined by comparing an RSSI or phase predicted distance associated with the RSSI signature to an actual known distance between reader and RFID tag, as will be explained in greater detail below. Using the RSSI signatures and corresponding errors, training engine 155 may create and define an error prediction function 160 for use in predicting error in future distance estimations using either RSSI or phase. Once the error prediction function 160 is defined, it may receive as input an RSSI signature 180 associated with a tag being tracked, and output a predicted error 185 in a distance estimate associated with the tag. In an example embodiment, the error prediction function 160 may employ a classification scheme wherein discrete categorization of predicted error values 185 is provided. In another example embodiment, the error prediction function 160 may implement a regression scheme in which predicted error values 185 are continuous values. Typically, the output of error prediction function 160 would depend upon the method used to train training engine 155.

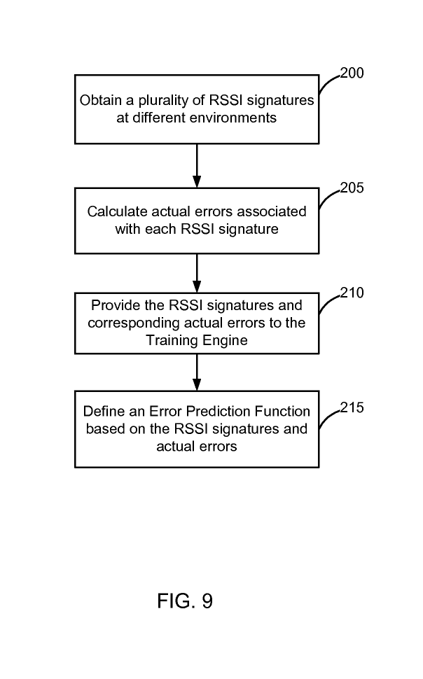

With reference to FIG. 9, a flowchart illustrating an example process of defining error prediction function 160 is shown. At block 200, a plurality of test RSSI signatures at different environments may be obtained using the reader associated with trainer 150. As previously mentioned, each RSSI signature includes RSSI values measured from multiple frequencies, such as at each of the 50 hop frequencies. At block 205, actual errors 167 associated with each RSSI signature may be calculated. Thereafter, the RSSI signatures 165 and corresponding actual errors 167 are provided to the training engine 155 as training examples at block 210. At block 215, training engine 155 may utilize one or more machine learning techniques to define the error prediction function 160. In an example embodiment, error prediction function 160 may be installed and/or provided in RFID tag detection device 35 for use thereby in predicting errors in distance estimates. In another example embodiment, error prediction function 160 may be provided in a remote computing device, such as a server, and accessible by RFID tag detection device 35 via a network connection.

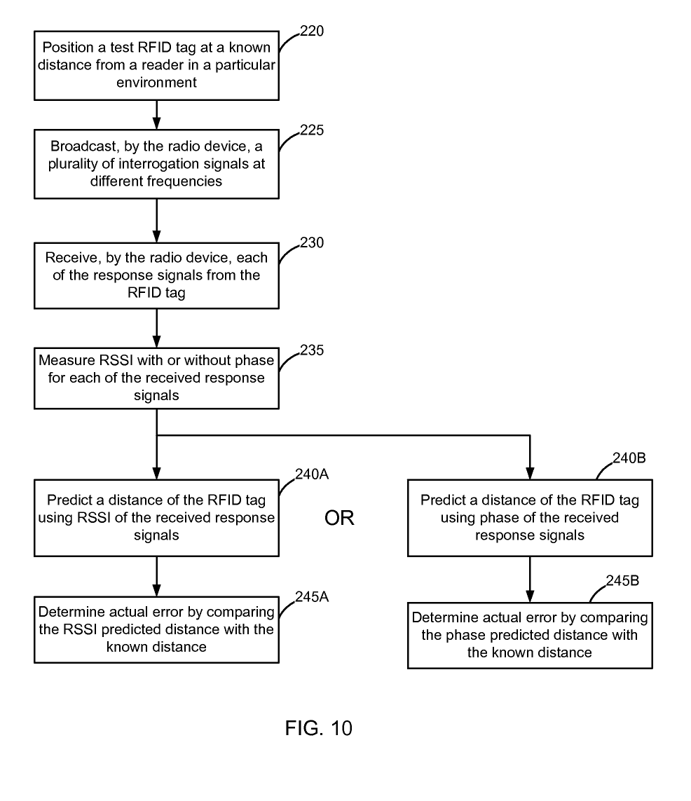

Referring now to FIG. 10, a flowchart of an example method of obtaining an RSSI signature and actual distance error associated therewith that are both fed into the training engine 155 as components of one training example, is illustrated. At block 220, a test RFID tag is positioned at a known distance from the reader associated with trainer 150 in a particular test environment. The known distance comprises the actual separation distance and the environment can be a real world environment or a controlled environment. To create an RSSI signature associated with the test RFID tag, the reader may broadcast a plurality of interrogation signals TX at different frequencies, such as at the 50 hop frequencies, to interrogate the test RFID tag at block 225. In response to each of the plurality of interrogation signals TX, the test RFID tag may respond by returning response signals RX at each corresponding frequency. The reader may receive each of the response signals RX at block 230, and measure RSSI, with or without phase, of each received response signal RX at block 235. The measured RSSI values may be used to comprise an RSSI signature associated with the test RFID tag. Thereafter, an estimate of the distance between the test RFID tag and the reader may be predicted by trainer 150 using either the measured RSSI values at block 240A, or using the phase measurements at block 240B.

In one example embodiment, RSSI of each received response signal RX may be measured with or without measuring phase thereof at block 235 depending on the method to be used in predicting distance. For example, when using RSSI measurements to predict the distance at block 240A, the reader may measure RSSI of each received response signal RX without measuring the phases of each at block 235, and when using phase measurements to predict the distance at block 240B, the reader may measure both RSSI and phase of each received response signal RX at block 235. Additionally, if RSSI measurements are to be used in predicting the distance (block 240A), then the training engine 155 may be provided with errors 167 that are determined using RSSI distance measurements. Similarly, if phase measurements are to be used in predicting the distance (block 240B), then the training engine 155 may be provided with errors 167 that are determined using phase-based distance measurements.

With respect to predicting distance using the measured RSSI values at block 240A, the RSSI values from the plurality of frequencies may be averaged to yield an average RSSI value, and the average RSSI value may be used to predict the distance. For example, the average RSSI value may be correlated to an empirically determined relationship between average RSSI and reader to tag distance, such as in a similar manner described above with respect to FIG. 2. It will be appreciated, however, that other techniques for determining distance estimates based on one or more RSSI measurements may be used. At block 245A, actual error in the RSSI predicted distance may be determined by comparing the RSSI predicted distance to the actual separation distance. For example, the actual error may be calculated by subtracting the RSSI predicted distance from the actual separation distance. As such, if the predicted distance is greater than the actual separation distance, the resulting error would be negative. Conversely, if the predicted distance is less than the actual separation distance, the resulting error would be positive. In other alternative embodiments, reverse logic to that described above may also be implemented.

With respect to predicting distance using the phase measurements at block 240B, a similar process described above with respect to FIGS. 4A-4B may be used. It is also contemplated that other techniques for determining distance estimates using phase measurements may be used. At block 245B, actual error in the phase predicted distance may be determined by comparing the phase predicted distance to the actual separation distance. For example, the actual error may be calculated by subtracting the phase predicted distance from the actual separation distance. As such, the resulting error can be negative or positive, depending on the predicted distance being greater than or less than the actual separation distance, respectively. In other alternative embodiments, reverse logic to that described above may also be implemented.

The foregoing described process of obtaining RSSI signature and corresponding actual error is repeated multiple times for different test RFID tags of the same type at different environmental conditions to obtain a plurality of RSSI signatures and errors to be used as training examples for training engine 155. Any sufficient number of training examples may be collected. More training examples, though, may provide the opportunity to define a more accurate error prediction function 160.

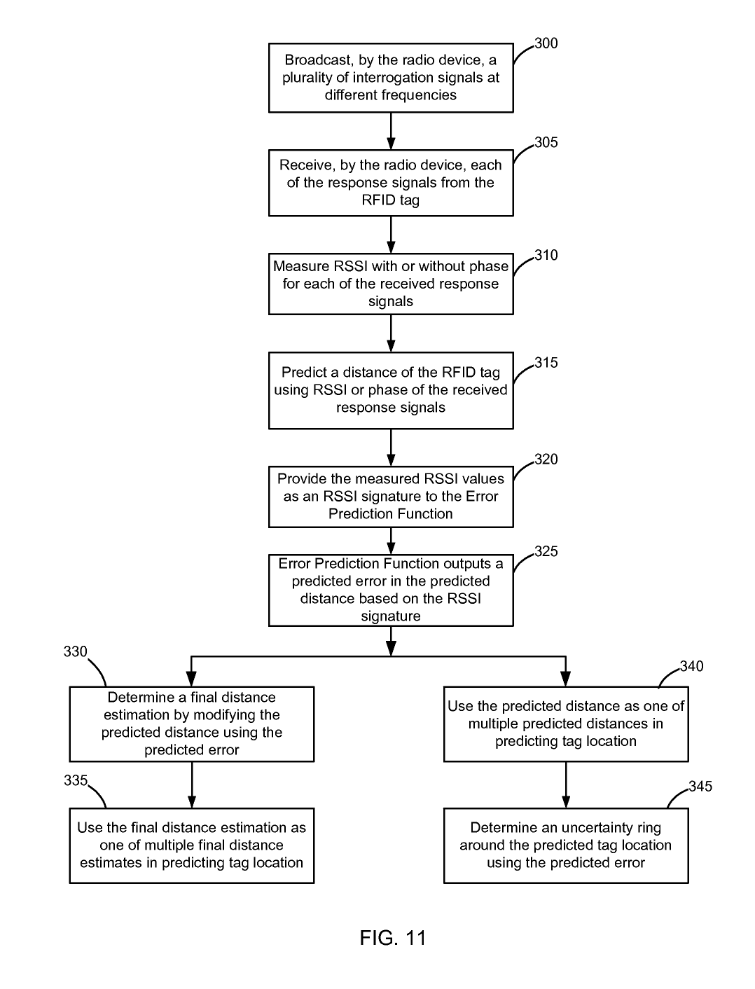

With reference to FIG. 11, a flowchart illustrating an example process of predicting distance of an unknown tag to be identified, tracked and/or monitored and, thereafter, predicting error in the predicted distance, is shown. At block 300, radio device 50 may broadcast a plurality of interrogation signals TX at different frequencies to interrogate the unknown RFID tag within interrogation range. In response to each of the plurality of interrogation signals TX, RFID tag 40 may respond by returning response signals RX at each corresponding frequency. Radio device 50 may receive each of the response signals RX at block 305, and measure RSSI, with or without phase, of each received response signal RX at block 310. At block 315, an estimate of distance between the unknown tag and radio device 50 may be predicted by RFID tag detection device 35 using measured RSSI values of the received response signals. Depending on the method to be used in distance estimations, radio device 50 may measure RSSI of each response signal RX with or without measuring phase thereof, as previously described with respect to block 235. At block 320, RFID tag detection device 35 may invoke error prediction function 160 and provide thereto the measured RSSI values as an RSSI signature. In response, the error prediction function 160 receives the RSSI signature and predicts an error in the predicted distance based on the RSSI signature at block 325. The predicted error may be used in the determination of the location and/or whereabouts of the unknown RFID tag.

In one example embodiment, the predicted error may be used to determine a final distance estimate for the unknown tag at block 330. More particularly, the final distance estimate may be determined by modifying the initial predicted distance based on the predicted error. For example, the final distance estimate may be determined by applying (adding or subtracting) the predicted error to the initial predicted distance depending on the sign of the predicted error. If the predicted error is negative, the predicted error may be subtracted from the initial predicted distance resulting in the final distance estimate being less than the initial predicted distance. Conversely, if the predicted error is positive, the predicted error may be added to the initial predicted distance resulting in the final distance estimate being greater than the initial predicted distance. With the predicted error being accounted for in determining the final distance estimate, error due to multipath may be reduced and a more accurate distance prediction may be provided.

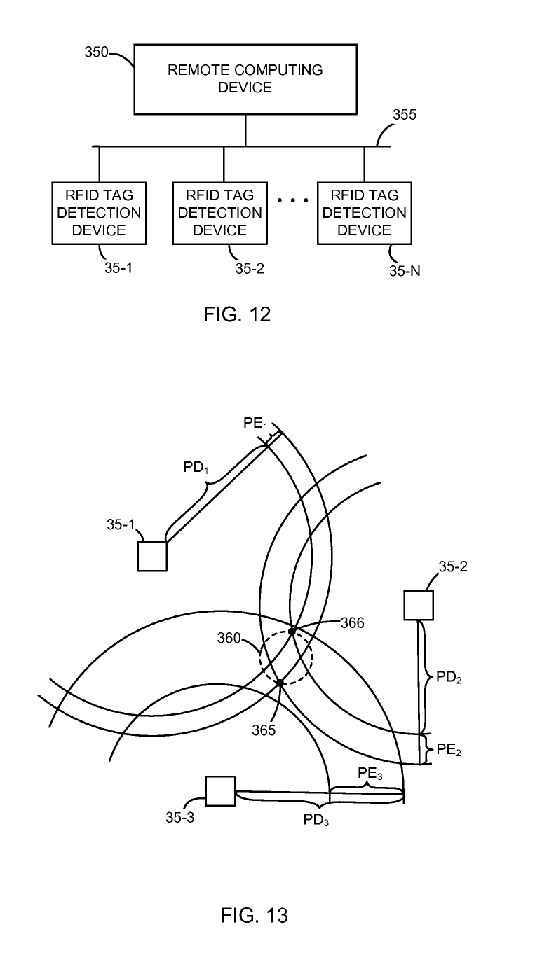

One or more reads on the same unknown RFID tag by multiple RFID tag detection devices 35 may be performed in order to perform localization on the unknown tag. For example, FIG. 12 shows a plurality of RFID tag detection devices 35-1 to 35-N connected to a central remote computing system or device 350, such as a server, via a network connection 355. Network connection 355 may have any one of a number of network topologies and signal protocols, and may be any type of network, including a local area network (LAN), a wide area network (WAN), a metropolitan area network (MN), or any other type of network capable of interconnecting different devices. Electronic communication between the devices may operate using a wired connection, such as for example, using Ethernet UTP or fiber optic cables, or a wireless networking standard, such as IEEE 802.XX. Each of the RFID tag detection devices may be positioned at various locations in an environment to localize unknown tags therein. In operation, each RFID tag detection device 35 may perform distance estimation on the unknown tag, predict error in the distance estimation using error prediction function 160, and provide a final distance estimate which takes into account the predicted error. For example, at block 335 (FIG. 11), the final distance estimate determined by an RFID tag detection device 35 may be used as one of multiple final distance estimates by remote computing device 350 when predicting a relative location or position of the unknown tag. The relative location or position of the unknown tag may be determined using one or more locating algorithms, such as trilateration, which utilize the final distance estimates determined by the RFID tag detection devices 35 which detected the unknown tag. Further, remote computing device 350 may use a mapping function to display the location of the unknown tag on a map, such as a floor plan of a building or work area. By using the final distance estimates with reduced error for localization, a more accurate location of the unknown tag may be determined.

In another example embodiment, distance estimates predicted at block 315 by multiple readers may be used to predict a relative position/location of the unknown tag at block 340, and errors predicted by the error prediction function 160 at block 325 may be used to establish an error bound or uncertainty ring around the predicted tag location at block 345 (FIG. 11). The error bound or uncertainty ring generally defines a tolerance zone within which the unknown tag may be located. As an illustrative example, FIG. 13 shows three RFID tag detection devices 35-1, 35-2, and 35-3, for performing localization on an unknown tag. Using distance estimation techniques described above, RFID tag detection devices 35-1, 35-2, and 35-3 may determine corresponding predicted distances PD1, PD2, and PD3, respectively. Using the error prediction function 160, corresponding errors PE1, PE2, and PE3 may be predicted for the predicted distances PD1, PD2, and PD3, respectively. In the example shown, the predicted errors PE1 and PE2 for predicted distances PD1 and PD2, respectively, are positive. On the other hand, predicted error PE3 for the predicted distance PD3 is negative. Corresponding predicted distances PD and predicted errors PE are illustrated as defining two concentric circles around corresponding RFID tag detection devices 35. For each RFID tag detection device 35, an area between two concentric circles generally defines a region of error for each respective distance measurement by the RFID tag detection devices 35. Ranging information and predicted errors may be forwarded by each RFID tag detection device 35 to remote computing device 350 for processing thereby.

In an example embodiment, the two smallest error measurements may be used by remote computing device 350 to determine a diameter of an uncertainty ring around the predicted location. The largest error measurement, on the other hand, may be used to resolve symmetrical ambiguity with respect to where the uncertainty ring can be drawn. In the example shown, the two smallest error measurements are provided by predicted errors PE1 and PE2, while the largest error measurement is provided by predicted error PE3. In one example embodiment, the area of overlap between the regions of error provided by the predicted errors PE1 and PE2 may be used to define the diameter of uncertainty ring 360. For example, the diameter of uncertainty ring 360 corresponds to the largest distance described by the circumferential intersections 365, 366 of the concentric circles which bound the regions of error for each RFID tag detection device 35-1, 35-2. Meanwhile, the concentric circles which bound the region of error for RFID tag detection device 35-3 are used to determine the quadrant where the uncertainty ring is drawn. The size of the uncertainty ring may be updated as the pattern changes. In this way, moving objects and other changes in the environment can be accounted for. Remote computing device 350 may display the location of the unknown tag as well as the uncertainty ring around the tag location on a map.

In other example embodiments, techniques provided herein may be used to monitor whether an object with an attached RFID tag has moved. For example, object detection system 30 may be used to determine if the RFID tag has moved by detecting relatively large changes in RSSI signature pattern associated with the RFID tag or when the detected change in RSSI signature pattern exceeds a predetermined metric. In still another example embodiment, monitoring of changes in RSSI signature patterns may be used to determine if an environment has changed enough to warrant a new calibration. Further, predicted tag locations may be combined with floor plan information to eliminate the need for location calibration, which can make installation of location systems significantly cheaper and easier.

It will be appreciated that the actions described and shown in the example flowcharts may be carried out or performed in any suitable order. It will also be appreciated that not all of the actions described herein need to be performed in accordance with the example embodiments of the disclosure and/or additional actions may be performed in accordance with other embodiments of the disclosure. The description of the details of the example embodiments have been described using RFID systems. However, it will be appreciated that the teachings and concepts provided herein may also be applicable to other localization systems employing radio technology. For example, the teachings and concepts provided herein may be used to reduce error in Bluetooth or Wi-Fi distance estimations.

The foregoing description of several example embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for determining a distance between a radio frequency identification (RFID) tag and a reader, comprising:
transmitting, by the reader, a plurality of interrogation signals to the RFID tag at a plurality of frequencies;
receiving, by the reader, a plurality of response signals from the RFID tag in response to the plurality of interrogation signals;
calculating a first distance estimate of the distance based on information associated with the at least one of the plurality of response signals received;
measuring a signal strength of each of the received plurality of response signals to create a received signal strength indicator (RSSI) signature;
predicting an error in the first distance estimate using the RSSI signature; and
determining a final distance estimate of the distance by modifying the first distance estimate based on the predicted error.

2. The method of claim 1, wherein the first distance estimate is one of an RSSI-based distance estimate and a phase-based distance estimate.

3. The method of claim 1, further comprising providing the final distance estimate to a remote computing device for use thereby in determining a location of the RFID tag.

4. The method of claim 1, wherein predicting the error comprises invoking an error prediction function that is defined based at least in part upon a plurality of RSSI signatures measured from a plurality of test RFID tags at different environmental conditions, the error prediction function receiving the created RSSI signature as input and outputting the predicted error based on the created RSSI signature.

5. The method of claim 4, wherein the error prediction function is further defined based upon distance errors associated with corresponding test RFID tags, each distance error being a difference between an actual distance and an estimated distance associated with a test RFID tag.

6. The method of claim 1, further comprising providing the first distance estimate and the predicted error to a remote computing device for processing thereby, the remote computing device for predicting a location of the RFID tag based at least upon the first distance estimate and defining an error bound around the predicted location based at least upon the predicted error.

7. A software program product stored in a non-transitory memory for predicting error in a distance estimate of a radio frequency identification (RFID) tag from a reader, the software program product having instructions which, when executed by a computing device, result in the following operations:
creating a received signal strength indicator (RSSI) signature associated with the RFID tag; and
using one or more machine learning algorithms, predicting an error in the distance estimate based upon the RSSI signature, the predicted error to be used in determining a location of the RFID tag.

8. The software program product of claim 7, wherein the instructions for predicting an error comprise instructions for invoking an error prediction function that is defined based at least in part upon a plurality of RSSI signatures associated with a plurality of test RFID tags, the error prediction function receiving the created RSSI signature as input and predicting the error in the distance estimate based on the created RSSI signature.

9. The software program product of claim 7, further comprising instructions for calculating the distance estimate based on information associated with at least one of a plurality of response signals received by the reader from the RFID tag.

10. The software program product of claim 7, further comprising instructions for calculating the distance estimate, wherein the distance estimate is one of an RSSI-based distance estimate and a phase-based distance estimate.

11. The software product of claim 7, further comprising instructions for calculating a second distance estimate of the RFID tag by modifying the distance estimate based on the predicted error, wherein determining the location of the RFID tag includes determining a location thereof based at least upon the second distance estimate.

12. The software product of claim 7, further comprising instructions for providing the distance estimate and the predicted error to a remote computing device to be used thereby in determining the location of the RFID tag and defining an error bound for the predicted location, respectively.

13. A method for determining location of an unknown tag using multiple readers, comprising:
receiving, by each reader, a set of plurality of response signals at a plurality of frequencies from the unknown tag in response to a plurality of interrogation signals by the reader at the plurality of frequencies;
for each set of plurality of response signals received by each reader, creating a received signal strength indicator (RSSI) signature comprised of signal strengths measured from the corresponding received set of plurality of response signals, estimating a distance to the unknown tag based on information associated with at least one response signal of the corresponding received set of plurality of response signals, and predicting an error associated with the estimated distance based on the RSSI signature; and
predicting, by a computing device in communication with the readers, a location of the unknown tag based on the estimated distances and predicted errors.

14. The method of claim 13, wherein predicting the location of the unknown tag is based on the estimated distances and includes defining an error bound around the predicted location based on the predicted errors.

15. The method of claim 14, wherein defining the error bound includes determining a diameter of the error bound based on at least two predicted errors having the least error measurements among the predicted errors.

16. The method of claim 14, further comprising detecting, by each reader, a change in the RSSI signature associated with the unknown tag, and updating, by the computing device, a size of the error bound as the RSSI signature changes.

17. The method of claim 13, wherein predicting the error includes invoking, by each reader, an error prediction function that is defined based at least in part upon a plurality of RSSI signatures measured from a plurality of test RFID tags at different environmental conditions, the error prediction function receiving the created RSSI signature as input and outputting the predicted error based on the created RSSI signature.

18. The method of claim 17, wherein the error prediction function is further defined based upon a difference between an actual separation distance and an estimated distance associated with each of the plurality of test RFID tags.

19. The method of claim 13, further comprising determining, by each reader, a second distance estimate of the unknown tag by modifying the estimated distance based on the corresponding predicted error, wherein predicting the location of the unknown tag includes determining a location thereof based on the second distance estimates.

20. The method of claim 13, further comprising monitoring movement of the unknown tag by detecting changes in the RSSI signature associated therewith.
